(19) United States
(12) Patent Application Publication
(10) Pub. No.: US 2007/0167091 A1
(43) Pub. Date: Jul. 19, 2007

(54) Implantable connection element for a fixation system

(76) Inventor: Jorg Schumacher, Tuttlingen (DE)

Correspondence Address: RATNERPRESTIA, P O BOX 980, VALLEY FORGE, PA, 19482-0980, US

(21) Appl. No.: 11/637,438

(22) Filed: Dec. 12, 2006

(30) Foreign Application Priority Data
Dec. 13, 2005 (DE) 10 2005 061 368.3

(51) Int. Cl. H01R 13/02

(52) U.S. Cl. 439/885

(57) ABSTRACT

An implantable connection element for an implantable fixation system, with a connecting section, which can be connected to an anchoring element, and with at least one end section forming a free end of the connection element and configured such that the at least one end section can be detachably connected to the connecting section.

The present disclosure relates to the subject matter disclosed in German patent application 10 2005 061 368.3 of Dec. 13, 2005, which is incorporated herein by reference in its entirety and for all purposes.

### BACKGROUND OF THE INVENTION

The present invention relates to an implantable connection element for an implantable fixation system, in particular for a spinal fixation system, with a connecting section, which can be connected to an anchoring element, and with at least one end section forming a free end of the connection element.

Connection elements of the above-described type are frequently used in surgery to fix bone parts, e.g. vertebrae of a spinal column, in a defined position relative to one another. For this purpose, they are usually fixed directly or indirectly to anchoring elements, e.g. bone screws, anchored in the bone parts using an attachment device. The connection elements, e.g. connection rods or connection plates, are frequently also inserted in a minimally invasive manner. To facilitate the insertion into a human or animal body, end sections forming the free ends of the connection elements are frequently configured in such a way that their cross-section tapers towards the free end, e.g. in the shape of a conical and/or rounded point.

This configuration of the connection element firstly facilitates the insertion of the connection element into muscle tissue and tissue surrounding this and also through corresponding openings of the anchoring element to receive the connection element.

However, a disadvantage of such connection elements is that the end section cannot be fixed to the anchoring element because of the reduction in cross-section. Therefore, the end section forming an insertion aid projects beyond the anchoring element after the connection element has been fixed in position, and can thus penetrate regions, e.g. adjacent vertebral segments, and cause irritations there that can lead to successive degeneration of the adjacent segment.

Therefore, it would be desirable to provide a connection element of the above-described type which prevents irritations and secondary injuries after implantation of the connection element.

### SUMMARY OF THE INVENTION

The present invention suggests to provide an implantable connection element of the above-described type wherein the at least one end section can be detachably connected to the connecting section or irreversibly removed from this.

The further development according to the invention has the advantage in particular that the end section of the connecting section can be detached or removed after the connection element has been inserted and fixed to an anchoring element. The connection element can then be selected in particular so that the end section is removed after the connection element has been fixed to the anchoring element, and the then free end of the connection element only protrudes minimally from the anchoring element. As a result, the free end of the connection element is prevented from being able to come into undesirable contact, for example, with adjacent bone parts, in particular vertebral bodies.

Advantageously, the connection element is a connection rod. A connection rod can be easily inserted into a human or animal body, in particular also in a non-invasive manner, while still having sufficient stability to securely hold bone parts that are to be connected to one another in the desired position. In particular, a connection rod can also be brought into a desired shape, e.g. curved, during a surgical procedure if it has a cross-section suitable for this.

The connection element is favourably configured in the form of a connection plate. A connection plate has the advantage over a connection rod that a higher connection rigidity can be achieved when connecting bone parts. It would be conceivable that at least one part of the connection plate is also configured in a rod shape.

To simplify the detachment or irreversible removal of the end section from the connecting section, it is advantageous if the end section is made from a resorbable material. This configuration renders a manual removal of the end section superfluous. This means that the connection element can be inserted into the body and fixed to an anchoring element in a desired way, and that the end section is automatically removed, e.g. by breaking down. It would also be conceivable that the point is broken down, for example, by irradiation with X-ray radiation, microwaves or ultraviolet light or laser light. The end section is preferably quickly resorbed, where possible, within a period of one to 30 days.

It is favourable if the resorbable material is gelatine, sugar, calcium phosphate or a biodegradable plastic. Alternatively, it would also be conceivable that the end section can evaporate or melt. For example, the end section could be made from ice or a polyvinyl alcohol (PVA) gel. Moreover, an alternative would be conceivable, wherein the end section is soft and thus cannot irritate the adjacent tissue or adjacent bone parts, since it yields upon contact.

The biodegradable plastic is preferably polylactide or polyglycolide. These plastics are biocompatible and break down in the desired manner.

To facilitate the insertion of the connection element into a body and minimise as far as possible any injuries in so doing, it is advantageous if the at least one end section is made from an elastic material. In particular, the elastic material can also be configured so that it is not elastic during insertion and only develops its elastic property again after insertion, e.g. as a result of a change in temperature or radiation treatment.

To enable the connection element to be inserted easily through muscle tissue, it is favourable if the at least one end section tapers conically.

It is advantageous if the at least one end section is configured in the shape of a point pointing away from the connecting section. This can easily separate tissue, through which the connection element has to be inserted into a body.

In order to prevent any injuries to tissue, through which the connection element is inserted, it is advantageous if the point is blunt or rounded.

Favourably, the at least one end section is curved. As a result, the connection element can also be directed virtually “around the corner” past bone parts or sensitive tissue, depending on access.

It is advantageous, in principle, if the at least one end section has a non-variable cross-section. As a result of this, the stability of the connection element is increased and also the insertion of the connection element is facilitated. However, it can also be favourable if the at least one end section has a variable cross-section. For example, the cross-section can be larger in an insertion position, in which the connection element can be inserted into a human or animal body, than in a position, in which the end section is to be removed again. This facilitates both the insertion of the connecting section and the removal of the connecting section from the body.

Advantageously, in a removal position the at least one end section has a cross-section, which is smaller than a cross-section of the connecting section. As a result, the end section can be removed in a particularly simple and gentle manner from the body after detachment from the connection element.

To facilitate the removal of the end section even further, it is advantageous if the connection element comprises an end section guide means, and if in the removal position the at least one end section is movable in the end section guide means. For example, a groove or channel can be provided on the connection element, in which the end section having a smaller cross-section than the connection element in the removal position can be moved, e.g. in the insertion direction of the connection element into the body. Thus, the end section can be easily removed again after the final positioning of the connection element in the body.

In order to simply reduce the end section in cross-section, it is advantageous if the at least one end section is foldable. Thus, it can be unfolded, for example, before insertion of the connection element in order to form a conical point, for example. For removal of only the end section from the body, this can then be folded again before or after detaching from the connecting section, and thus in its removal position can then be removed from the body again.

It is favourable if the end section comprises an envelope, which can be filled with a fluid. This configuration enables the end section to be moved in a simple manner, e.g. from a removal position, in which the envelope assumes a minimum volume, into an insertion position, in which the end section forms an insertion aid for insertion of the connection element into a human or animal body, e.g. by it assuming the shape of a point in the insertion position.

The construction of the connection element and its production can be simplified further if the envelope is inflatable. Alternatively, it would also be conceivable to fill the envelope with a biocompatible liquid, e.g. an isotonic saline solution.

The structure of the connection element is particularly simple if the at least one end section is foldable in an umbrella-like manner. This enables a point to be configured in a simple way that facilitates insertion into the body. After insertion, the end section can thus be folded up in a simple manner and removed from the body again.

The structure of the connection element is simplified further if the at least one end section has a foldable frame and a covering defining an outer surface of the at least one end section. For example, the frame and the covering can also be made from a resorbable material. In addition, this structure has the advantage that it can have a certain elasticity, as a result of which injuries to tissue, through which the connection element is inserted into the body, are minimised.

To enable the end section to automatically assume the shape of a point, it is favourable if the frame comprises at least one spring element to move the end section from the removal position into an insertion position, in which the at least one end section forms a tapering point.

It is advantageous if the frame is made from a material capable of deforming when thermally activated. This allows various embodiments, for example, an end section that compresses when thermally activated. For example, an end section that is foldable in an umbrella-like manner could be cooled before insertion into a human body and assume its insertion position, e.g. in the shape of a conically tapering point. As a result of thermal activation through the prevailing temperature in the body, the frame could then deform and automatically fold down the end section again.

A deformation of the end section, in particular the frame, can be thermally activated in a simple manner if the deformable material is a shape memory alloy.

Favourably, the frame is made from a titanium-nickel alloy that is distinguished by virtue of its biocompatibility.

It would be conceivable, in principle, to connect the end section and the connecting section to one another mechanically. However, it is advantageous if the at least one end section is injection moulded onto the connecting section. For example, a plastic end section can thus be connected to the connecting section in a simple manner. Moreover, a connection of the end section and the connecting section can thus be improved in a simple way by undercuts.

In addition, according to a preferred embodiment of the invention it can be provided that a connection device for the detachable connection of the at least one end section and the connecting section is provided, that the connection device comprises two coupling members, which can be brought into engagement with one another, and that one of the two coupling members is arranged on at least one end section and that the other of the two coupling members is arranged on the connecting section. By means of the two coupling members the at least one end section and the connecting section can be connected to one another in a simple manner and can also be detached from one another, i.e. reversibly or irreversibly.

To prevent unintended detachment of the at least one end section from the connecting section, it is advantageous if an undercut is provided to hold the coupling members against one another in a connection position.

It is favourable if the connection device comprises at least one attachment element to fix the at least one end section to the connecting section. For example, a connection of the at least one end section and the connecting section can be additionally secured with the attachment element.

The connection element can be configured in a particularly simple manner if the at least one attachment element is a locking pin, a screw or a rivet. The at least one end section and the connecting section can be connected to one another in a simple manner with a screw or rivet.

The at least one end section can be connected to the connecting section without additional attachment elements if the connection device is configured in the form of a screw connection, and if one coupling member comprises an internal thread section and if the other coupling member comprises a corresponding external thread section. The end section and the connecting section can thus be screwed together in a simple manner and therefore also detached from one another.

A further alternative for a simple connection between the at least one end section and the connecting section can be achieved in that the connection device is configured in the form of a locking connection, and that one coupling member is configured in the form of a first locking member and that the other coupling member is configured in the form of a second locking member, which can be locked to the first locking member in a locking position. For example, the locking members can be locking projections and locking recesses that can be arranged to be partially resilient relative to one another.

In addition, it can be advantageous if the connection device is configured in the form of a positive connection, and if one coupling member can be inserted positively into the other coupling member. For example, a plug-in connection can thus be formed, wherein the connecting section and the at least one end section are simply plugged together.

A particularly simple configuration results if one coupling member is configured in the form of a blind hole and the other coupling member is configured in the form of a corresponding peg, which can be inserted into the blind hole. Irrespective of the configuration of the connection device, the coupling members can also be formed so that they are connected to one another by clamping in a connection position of the connecting section and end section.

According to a preferred embodiment of the invention, a predetermined breaking point can also be provided for separation of the at least one end section from the connecting section. In particular, it would be conceivable to configure the end section and the connecting section in one piece and enable separation of the end section from the connecting section by means of the predetermined breaking point. Naturally, it is also possible when a predetermined breaking point is provided that the end section can firstly be connected to the connecting section, i.e. that the end section and connecting section are also configured in two parts.

The structure of the connection element is particularly simple if the predetermined breaking point is configured in the form of a cross-sectional taper of the at least one end section. In particular, it can be arranged in the transition area between the connecting section and end section.

Advantageously, the cross-sectional taper of the at least one end section directly adjoins the connecting section. As a result of this, it can be ensured that after the end section has been separated this is detached practically completely from the connecting section and no longer protrudes from an anchoring element in an undesirable manner.

Advantageously, the at least one end section has at least one tool seat. The tool seat enables the at least one end section to be held in a simple manner with a suitable instrument for it and detached from the connecting section.

The at least one tool seat is preferably configured in the form of a recess. A projection of a removal tool, for example, can engage into a recess in a simple manner to grip the end section.

The structure of the connection element is particularly simple if the tool seat is configured in the form of a bore or a blind hole, the longitudinal axis of which is configured transversely or substantially transversely to the longitudinal axis of the at least one end section.

Alternatively, the tool seat can also be configured in the form of a groove, a perforation, an undercut or a threaded section, wherein in all cases the end section is also detachable from the connecting section with a special instrumentarium.

Moreover, the end section can be made from a material that is not transparent to X-rays. This allows determination of whether the end section has already been resorbed by the body in the desired manner without a further surgical procedure having to be conducted.

In addition, the above-defined object is achieved according to the invention with a surgical, in particular implantable, fixation system for fixing at least two bone parts in a defined relative position, which comprises at least one implantable anchoring element and at least one implantable connection element, wherein the at least one implantable connection element has a connecting section, which can be connected to the anchoring element, and at least one end section forming a free end, in that the at least one end section can be detachably connected to the connecting section or irreversibly removed from this. This further development according to the invention of a surgical fixation system has the advantage that after removal from the connecting section the end section on the connection element cannot cause irritations or degeneration of surrounding tissue or adjacent bone parts.

It is advantageous if the fixation system is a spinal fixation system for fixing at least two vertebrae of a human or animal spinal column in a defined relative position. Such a spinal fixation system enables damages to the spinal column to be treated simply and reliably.

According to a preferred embodiment of the invention, it can be provided that the at least one connection element of the fixation system is one of the above-described connection elements. The provision of such a connection element has the advantages described above.

To be able to fix the fixation system in a simple manner to a bone, for example, it is advantageous if the at least one anchoring element is configured in the form of a bone screw.

It would be conceivable, in principle, to fix the connection element directly to the anchoring element. However, it is advantageous if the at least one anchoring element comprises an anchoring section, which can be fixed in a bone, and a connection device, which can be connected to this, and if the connection device and the connecting section can be detachably connected.

This enables different connecting sections to be connected to different connection devices and different connection elements. Thus, the variability of the fixation system is increased, since a surgeon can select on an individual basis those parts that are best suited to connect two bone parts to one another by means of the fixation system.

The anchoring element can be connected to the connection element in a particularly simple manner if the connection device has a connection element seat for the at least one connection element and an attachment element to fix the at least one connection element in the connection element seat. For example, the connection element seat can be configured in the form of a substantially U-shaped fork head, to which the connection element can be fixed with a screw-type nut or with an adjusting screw.

### BRIEF DESCRIPTION OF THE DRAWINGS

The following description of preferred embodiments of the invention serves more detailed explanation in association with the drawing:

FIG. 1 is a perspective view of a fixation system according to the invention connecting two bone parts to one another;

FIG. 2 is a perspective view of a second embodiment of a connection element;

FIG. 3 is a perspective view of a third embodiment of a connection element;

FIG. 4 is a perspective view of a fourth embodiment of a connection element;

FIG. 5 is a perspective view of a fifth embodiment of a connection element;

FIG. 6 shows a sixth embodiment of an end section;

FIG. 7 shows a seventh embodiment of an end section;

FIG. 8 shows a eighth embodiment of an end section;

FIG. 9 shows a ninth embodiment of an end section; and

FIG. 10 is a sectional perspective view in partial section of a tenth embodiment of a connection element.

### DETAILED DESCRIPTION OF THE INVENTION

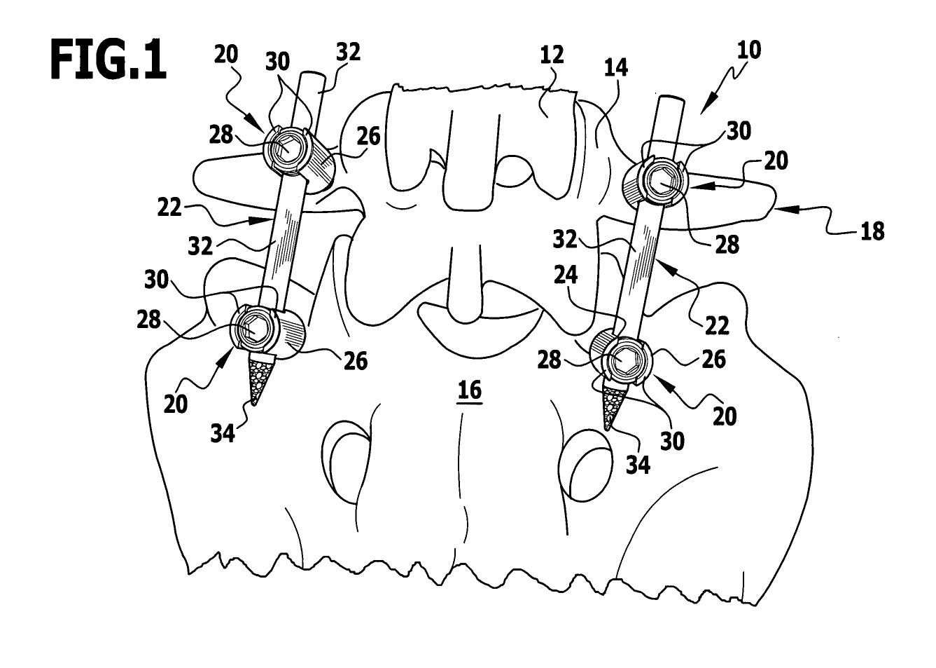

FIG. 1 shows a fixation system given the overall reference 10 in the form of a spinal fixation system, which serves in particular to predetermine and maintain a relative position of adjacent vertebrae 12, 14 or the sacrum 16 of a human or animal spinal column 18. The fixation system 10 comprises in particular anchoring elements 20, which can be anchored in bony structures of the spinal column 18 such as the bone or pedicle screws 20 shown in FIG. 1, for example. The fixation system 10 additionally comprises a connection element 22 in the form of a connection rod 22 shown in FIG. 1, for example, which can be inserted into a fork-shaped head 26 of the anchoring element 20 defining the connection element seat 24, and with an attachment element in the form of an adjusting screw 28, for example, which can be screwed in between the two half-shell-shaped side walls 30 of the head 26, i.e. by virtue of the threaded sections provided on the side walls 30 that correspond to an external thread of the adjusting screw 28.

The connection element 22 has an elongated rod-shaped connecting section 32 with a circular cross-section that can be inserted into the connection element seats 24 and can be fixed in position with the adjusting screw 28. An end section 34 arranged on one or both of the free ends of the connecting section 32 is configured in the form of a conical point that is slightly rounded at its tapering end.

The end section 34 can be detachably connected to the connecting section 32. This means that the end section 34 can be connected to the connecting section 32 before the connection element 22 is inserted into a human or animal body. This significantly facilitates the insertion of the connection element 22 into the human or animal body, since the end section 34 with the shape of a point can penetrate muscle tissue significantly more easily than a blunt end of the connecting section 32, and therefore injuries to tissue are reduced.

Since the end section 34 projects slightly from the connecting element seat 24 after the connection element 22 has been fixed to the anchoring element 20, it can lead to irritations and in the worst case even to degeneration of soft or bony tissue. Therefore, in the embodiment of a connection element according to the invention shown in FIG. 1 the end section 34 is detachable, in particular irreversibly removable, from the connecting section 32. For this purpose, it is made from a resorbable material, e.g. gelatine, sugar, calcium phosphate or from a biodegradable plastic, which can be polylactide or polyglycolide, for example. It would also be conceivable to make the end section 34 from ice or a PVA gel (polyvinyl alcohol gel), so that the end section 34 can break down easily as a result of heating after insertion into a human or animal body.

Alternatively, the end section 34 can also be made from a material, which can break down as a result of an irradiation with X-rays, microwaves and/or ultraviolet radiation or irradiation with laser light. It would also be conceivable to thermally break down the point by coupling it to inductive energy.

A resorbable or dissoluble end section 34 typically detaches from the connecting section 32 within a few days. Depending on the material used, this process can also amount to only a few minutes or hours. Depending on the selected material, the end section 34 can also be differently coloured.

The end section 34 can also be made from an elastic material, wherein the elasticity of the material can change because of external influences. For example, the end section 34 can be inelastic when the connection element 22 is inserted into a human or animal body and achieve a certain elasticity only after the final fixture of the connection element 22 to the anchoring element 20.

To connect the end section 34 and the connecting section 32 to one another, a connection device can be provided, which comprises two coupling members that can be brought into engagement with one another, wherein one of the two coupling members is arranged on the end section 34 and the other of the two coupling members is arranged on the connecting section 32. Optionally, the end section 34 can also be connected to a magnet, or be connected to the connecting section 32 by means of an adhesive.

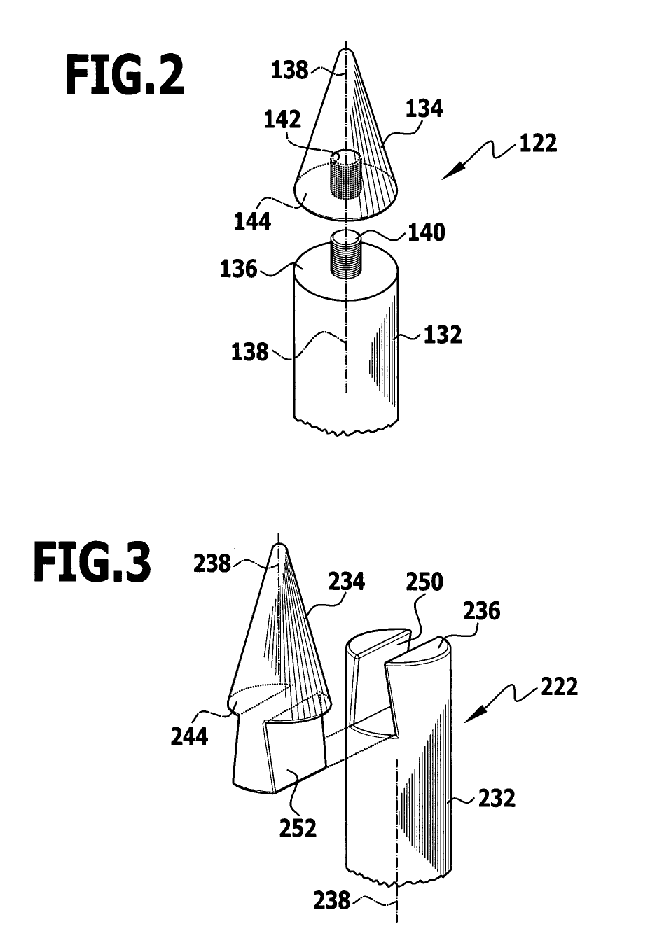

FIG. 2 shows a second embodiment of a connecting element, given the overall reference 122 and having a rod-shaped connecting section 132 and an end section 134 shaped to correspond to the end section 34. A connection device in the form of a screw connection comprises a threaded bolt 140, which protrudes from a face 136 of the connecting section 132 in the direction of the longitudinal axis of the face 136, its external thread corresponding to an internal thread of a blind hole 142, which is configured on the end section 134 in a circular base 144 facing the face 136 and likewise extends in the direction of the longitudinal axis 138. The end section 134 can be made from one of the materials described above.

A third embodiment of a connection element according to the invention is provided with the overall reference 222 in FIG. 3. It comprises an elongated rod-shaped connecting section 232 and also an end section 234, which can be connected to the connecting section 232 by means of a connection device comprising two coupling members. One of the two coupling members is formed by a dovetail groove 250 arranged transversely to the longitudinal axis 238 of the connecting section 232 in a face 236 thereof. A coupling member corresponding to this is formed by a dovetailed spring 252, which is arranged to protrude from a circular base 244 of the end section 234. For connection of the connecting section 232 and the end section 234, the two parts are moved relatively to one another, so that the spring 252 can be inserted into the dovetail groove 250 in a direction transverse to the longitudinal axis 238. In addition to the positive-locking shape, the spring 252 and the dovetail groove 250 can be configured so that the spring 252 is held clamped in the dovetail groove 250. The end section 234 can also be made from one of the above-described materials.

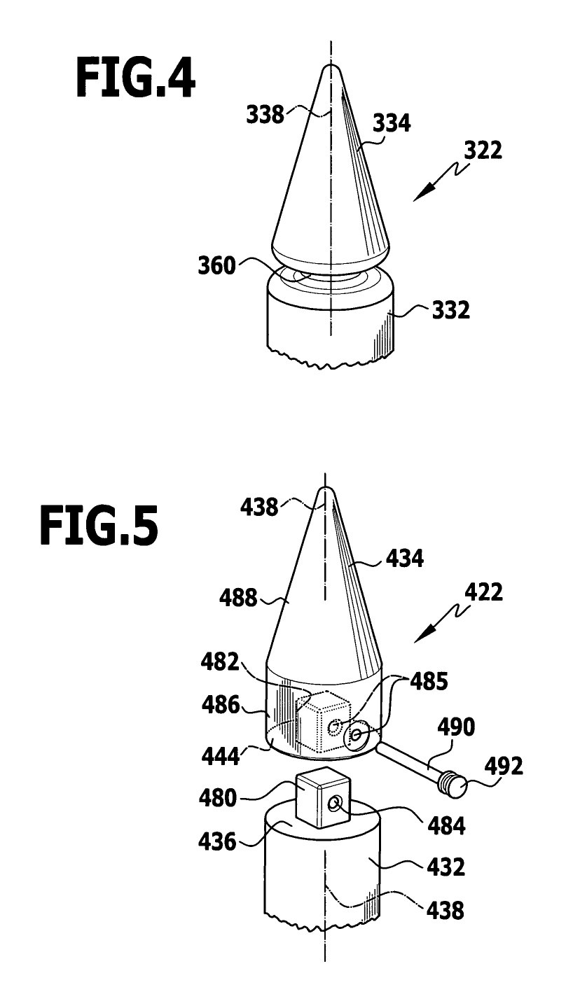

A fourth embodiment of a connection element given the overall reference 322 is shown in FIG. 4. It comprises an elongated connecting section 332 defining a longitudinal axis 338 and an end section 334 moulded onto this in one piece, its shape corresponding to the end section 34 configured in the form of a conical point. In the transition area between the end section 334 and the connecting section 332 a predetermined breaking point 360 is provided, which is configured in the form of an annular groove. The end section 334 is easily detachable from the connecting section 332 by means of the predetermined breaking point 360, so that it can be broken off from the connecting section 332 in particular after insertion of the connection element 322.

Alternatively, it would also be conceivable to provide the predetermined breaking point 360 on the end section 334, since it is made, for example, from a material such as that described in association with FIG. 1 and/or can be connected to the connecting section 332 as described in association with FIGS. 2 and 3.

FIG. 5 shows a connection element given the overall reference 422, which likewise comprises an elongated rod-shaped connecting section 432 defining a longitudinal axis 438. Protruding from a face 436 of the connecting section 432 is a substantially cubic projection 480, which is provided with a bore 484 extending transversely to the longitudinal axis 438. The connection element additionally comprises an end section 434, which has a short cylindrical section 486 and a conical section 488 adjoining this, which substantially corresponds in shape to the end section 34. A substantially cubic recess 482 corresponding to the projection 480 is provided in a base 444 of the section 486 to positively receive the projection 480. A bore 485 is provided in the cylindrical section 486 coaxially to bore 484, so that a locking pin 490 can be pushed through bores 485 and 484 transversely to the longitudinal axis 438 after the projection 480 has been inserted into the recess 482 in order to detachably connect the end section 434 to the connecting section 432. In this case, the locking pin 490 is preferably configured so that it is held clamped in the bores 484 and 485 and additionally has a head 492 that defines an abutment, so that the locking pin 490 cannot be pushed through the two bores 484 and 485.

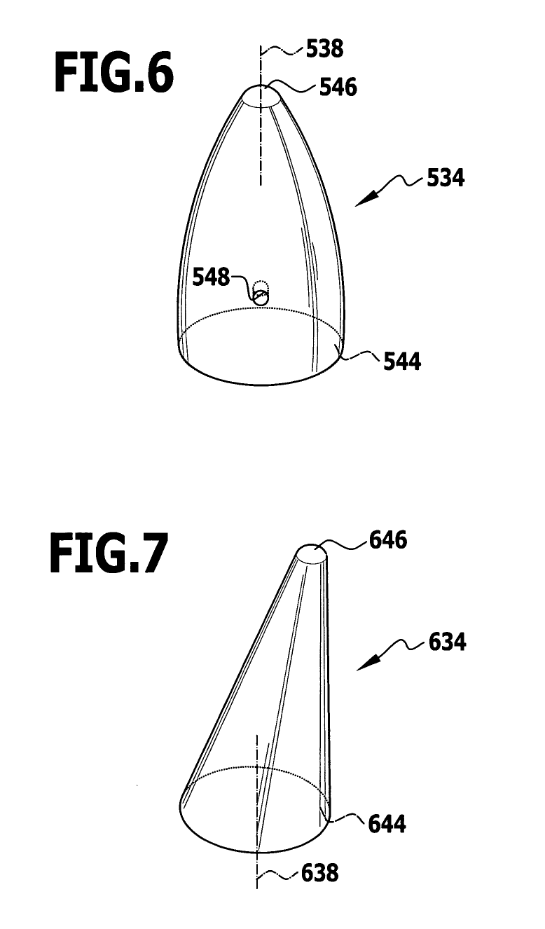

Four alternative configurations of end sections given the overall references 534, 634, 734 and 834 are shown in FIGS. 6 to 9. The end sections 534, 634, 734 and 834 shown in FIGS. 6 to 9 can also be used in particular in place of end sections 34, 134, 234, 334 and 434 in the embodiments of connection elements 22, 122, 222, 322 and 422 described in association with FIGS. 1 to 5.

The end section 534 shown in FIG. 6 has a spherical shape and preferably has a plane base 544 with a circular cross-section. A point 546, which forms an end of the end section 534 opposite the base 544, is slightly rounded to prevent injuries during the insertion of a connection element fitted with the end section 534 through tissue of a human or animal body. As shown in FIG. 6, the end section 534 is rotationally symmetric to a longitudinal axis 538, which can correspond in particular to a longitudinal axis of a connecting section (not shown).

The end section 634 shown in FIG. 7 is formed asymmetrically with respect to a longitudinal axis 638, which is defined by a circular base 644 of the end section 634. A point 646 of the end section 634 tapering away from the base 644 lies above the base 644, but close to its edge.

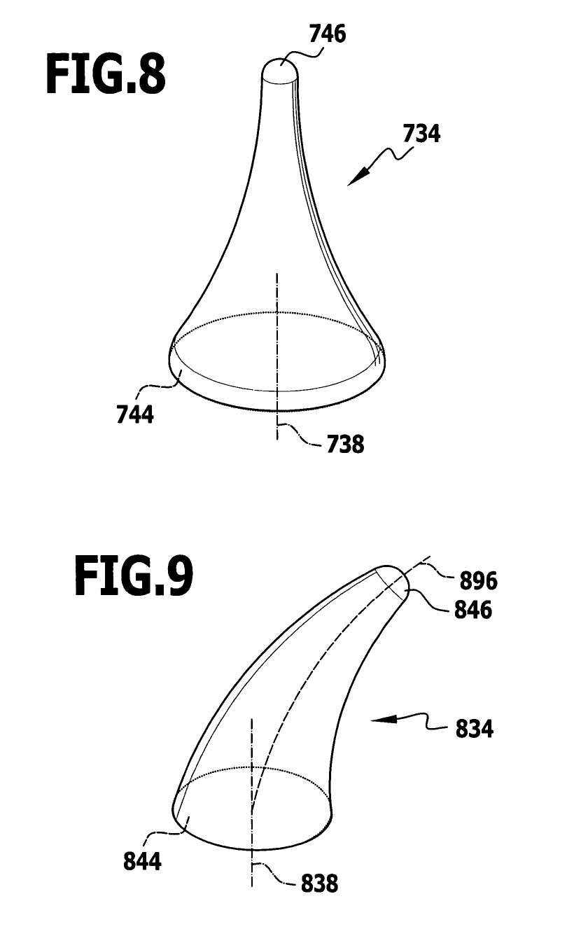

The end section 734 shown in FIG. 8 is formed rotationally symmetrically with respect to a longitudinal axis 738, wherein a cross-section of the end section 734 is tapered towards a rounded point 746, but not linearly as in the case of end section 34.

The end section 834 shown in FIG. 9 is configured asymmetrically with respect to a longitudinal axis 838 defined by a circular base 844. A centre line 896 of the end section 834 extending from the base 844 is curved away from the longitudinal axis 838 towards a blunt rounded point 846.

To remove the end sections described in FIGS. 1 to 9, removal aids can be provided on these, e.g. in the form of a blind hole 548 arranged on the end section 534, as shown in FIG. 6, transversely to the longitudinal axis 538. Alternatively, annular grooves or perforations as well as flattened portions on the end section would also be conceivable. In addition, a thread could also be provided as removal aid in an end section, so that with the described variants of the removal aids the respective end sections are removable in a simple manner from the human or animal body with the assistance of a special set of instruments after insertion and fixture of the connection elements.

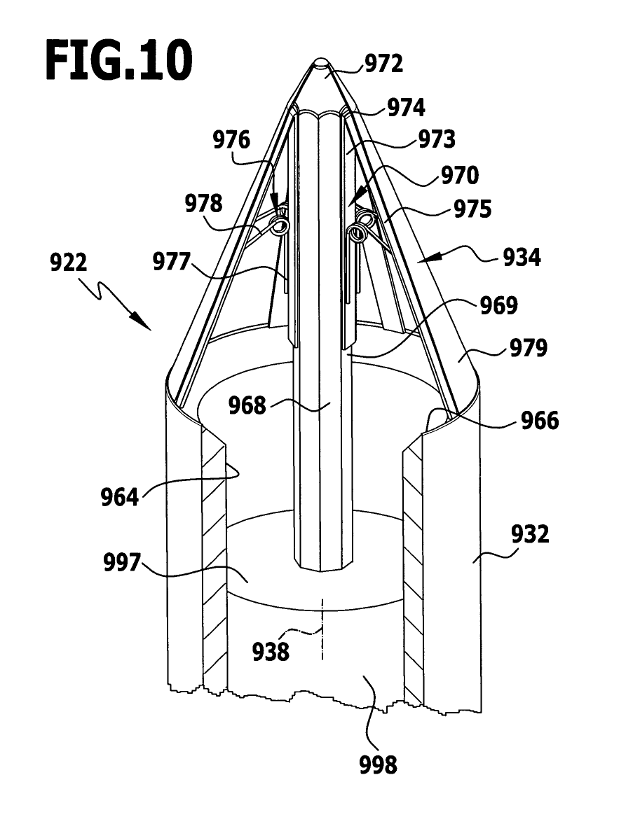

FIG. 10 shows a further embodiment of a connection element according to the invention given the overall reference 922. It comprises a tubular shaft-shaped connecting section 932 and also a conically tapering end section 934.

The tubular shaft-shaped connecting section 932 has an opening 964, which extends coaxially to a longitudinal axis thereof and has a circular cross-section, and which forms an end section guide means. A face edge 966 of the connecting section 932 is inclined towards the longitudinal axis 938, i.e. at about an angle of about 450 relative to the longitudinal axis 938.

The end section 934 is configured in the manner of an umbrella overall. A rod 968, which has an octagonal cross-section and forms a part of a frame 970, extends coaxially to the longitudinal axis 938. The rod 968 is configured in the form of a pencil and tapers to a point at one end. Extending from the pointed end 972 of the rod 968, small elongated parallelepipedal plates 973 are arranged on each side face 969 as further frame parts, which are articulated to a likewise elongated board-shaped wing 975 by means of a film hinge 974. Coil springs 976 serve to spread the wings 975, wherein one free end 977 of the coil spring 976 extending linearly and transversely to a longitudinal axis defined by the coil spring is fastened to the small plate 973 and the other free end 978 of the coil spring 976, which likewise points transversely to its longitudinal axis, is supported on the wing 975. The coil spring 976 is arranged so that both free ends 977 and 978 spread the small plates 973 or wings 975 that are articulated to one another. The wings 975 are provided with a covering 979 on the outside, which defines a conical outer surface.

The rod 968 is arranged on a face 997 of an elongated cylindrical pushing and pulling member 998, which is displaceable coaxially to the longitudinal axis 938 in the end section guide means in the interior of the connecting section 932.

For insertion of the connection element 922 into a human or animal body, the end section 934 is moved relatively to the connecting section 932 into the insertion position shown in FIG. 10. In this, the end section 934 forms a tapering point, similar to that in the case of connection element 22.

After insertion and fixture of the connecting section 932 to an anchoring element, e.g. anchoring element 20, the troublesome end section 934 is removed by displacing the pushing and pulling member 998 further into the connecting section 932. As a result, the rod 968 is also pulled into the connecting section 932 causing free ends of the wings 975 to slide on the inclined edge 966, and thus the free ends 977 and 978 of the coil springs 976 are pressed against one another. Thus, the wings 975 are pivoted towards the small plates 973 against the action of the coil springs 976. If the pushing and pulling member 998 is pushed further into the connecting section 932, the wings 975 covered with the covering 979 also slide into the interior of the connecting section 932. The pushing and pulling member 998 is retracted until the end section 934 completely disappears in the opening 964 of the connecting section 932.

As described, the end section 934 has a variable cross-section. The frame 970 can also assume the insertion position shown in FIG. 10 as a result of thermal activation. For example, the coil springs 976 can be “frozen” in the removal position and automatically move into the insertion position after heating. The coil springs are preferably made from a shape memory alloy.

Moreover, it would also be conceivable to configure an end section that has the shape of end section 34, for example, to be inflatable, i.e. by arranging an envelope that has and defines the desired shape of the end section on the connecting section, which can be changed from a collapsed or folded form into an inflated position either directly or through a channel provided in the connecting section with a fluid, e.g. a biocompatible liquid such as an isotonic saline solution, for example, or a gas, in particular air or nitrogen. If the envelope is filled with a fluid, then the connection element can be easily inserted into a human or animal body. After insertion, it is possible to discharge the fluid from the envelope or, if it is biocompatible, leave it in the envelope, which is preferably made of a resorbable material, until it is released after the envelope has broken down and can be absorbed by the body without damaging it.

1. An implantable connection element for an implantable fixation system comprising:
a connecting section configured to be connected to an anchoring element; and
at least one end section forming a free end, the at least one end section being detachably connected to or irreversibly removable from the connecting section.

2. The implantable connection element according to claim 1, wherein the connection element is a connection rod.

3. The implantable connection element according to claim 1, wherein the connection element is configured in the form of a connection plate.

4. The implantable connection element according to claim 1, wherein the at least one end section is made from a resorbable material.

5. The implantable connection element according to claim 4, wherein the resorbable material is gelatine, sugar, calcium phosphate or a biodegradable plastic.

6. The implantable connection element according to claim 4, wherein the resorbable material is a biodegradable plastic in the form of polylactide or polyglycolide.

7. The implantable connection element according to claim 1, wherein the at least one end section is made from an elastic material.

8. The implantable connection element according to claim 1, wherein the at least one end section tapers conically.

9. The implantable connection element according to claim 1, wherein the at least one end section is configured in the shape of a point pointing away from the connecting section.

10. The implantable connection element according to claim 9, wherein the point is blunt or rounded.

11. The implantable connection element according to claim 1, wherein the at least one end section is curved.

12. The implantable connection element according to claim 1, wherein the at least one end section has a variable cross-section.

13. The implantable connection element according to claim 12, wherein, in a removal position, the at least one end section has a cross-section which is smaller than a cross-section of the connecting section.

14. The implantable connection element according to claim 13, wherein the connection element comprises an end section guide means, and in the removal position, the at least one end section is movable in the end section guide means.

15. The implantable connection element according to claim 12, wherein the at least one end section is foldable to reduce its cross-section.

16. The implantable connection element according to claim 15, wherein the at least one end section is foldable in an umbrella-like manner.

17. The implantable connection element according to claim 1, wherein the end section comprises a liquid fillable envelope.

18. The implantable connection element according to claim 17, wherein the envelope is inflatable.

19. The implantable connection element according to claim 12, wherein the at least one end section has a foldable frame and a covering defining an outer surface of the at least one end section.

20. The implantable connection element according to claim 19, wherein the frame comprises at least one spring element to move the end section from a removal position to an insertion position in which the at least one end section forms a tapering point.

21. The implantable connection element according to claim 19, wherein the frame is made from a thermally activated deformable material.

22. The implantable connection element according to claim 21, wherein the deformable material is a shape memory alloy.

23. The implantable connection element according to claim 19, wherein the frame is made from a titanium-nickel alloy.

24. The implantable connection element according to claim 1, wherein the at least one end section is injection moulded onto the connecting section.

25. The implantable connection element according to claim 1 further comprising a connection device for the detachable connection of the at least one end section and the connecting section, the connection device comprising two coupling members which can be brought into engagement with one another, and one of the two coupling members is arranged on at least one end section and the other of the two coupling members is arranged on the connecting section.

26. The implantable connection element according to claim 25, wherein an undercut is provided to hold the coupling members against one another in a connection position.

27. The implantable connection element according to claim 25, wherein the connection device comprises at least one attachment element to fix the at least one end section to the connecting section.

28. The implantable connection element according to claim 27, wherein the at least one attachment element is a locking pin, a screw or a rivet.

29. The implantable connection element according to claim 25, wherein the connection device is configured in the form of a screw connection, and one coupling member comprises an internal thread section and the other coupling member comprises a corresponding external thread section.

30. The implantable connection element according to claim 25, wherein the connection device is configured in the form of a locking connection, and one coupling member is configured in the form of a first locking member and the other coupling member is configured in the form of a second locking member which can be locked to the first locking member in a locking position.

31. The implantable connection element according to claim 25, wherein the connection device is configured in the form of a positive connection and one coupling member is configured for positive insertion into the other coupling member.

32. The implantable connection element according to claim 31, wherein one coupling member is configured in the form of a blind hole and the other coupling member is configured in the form of a corresponding peg insertable into the blind hole.

33. The implantable connection element according to claim 1, wherein a predetermined breaking point is provided for separation of the at least one end section from the connecting section.

34. The implantable connection element according to claim 33, wherein the predetermined breaking point is configured in the form of a cross-sectional taper of the at least one end section.

35. The implantable connection element according to claim 34, wherein the cross-sectional taper of the at least one end section directly adjoins the connecting section.

36. The implantable connection element according to claim 1, wherein the at least one end section has at least one tool seat.

37. The implantable connection element according to claim 36, wherein the at least one tool seat is configured in the form of a recess.

38. The implantable connection element according to claim 36, wherein the tool seat is configured in the form of a bore or a blind hole, a longitudinal axis of which is configured transversely or substantially transversely to a longitudinal axis of the at least one end section.

39. An implantable fixation system for fixing at least two bone parts in a defined relative position, comprising at least one implantable anchoring element and at least one implantable connection element, wherein the at least one implantable connection element has a connecting section configured to be connected to the anchoring element, and at least one end section forming a free end, the at least one end section detachably connected to or irreversibly removable from the connecting section.

40. The fixation system according to claim 39, wherein the fixation system is a spinal fixation system for fixing at least two vertebrae of a human or animal spinal column in a defined relative position.

41. The fixation system according to claim 39, wherein the at least one end section is made from a resorbable material.

42. The fixation system according to claim 39, wherein the at least one anchoring element is configured in the form of a bone screw.

43. The fixation system according to claim 39, wherein the at least one anchoring element comprises an anchoring section configured to be fixed in a bone and a connection device configured to be connected to the anchoring section, the connection device and the connecting section being detachably connected.

44. The fixation system according to claim 43, wherein the connection device has a connection element seat for the at least one connection element and an attachment element to fix the at least one connection element in the connection element seat.
